(19) United States
(12) Patent Application Publication
(10) Pub. No.: US 2004/0094499 A1
(43) Pub. Date: May 20, 2004

(54) Nipple with extended sleeve

(76) Inventor: Der-Da Huang, Chang Hua Hsien (TW)

Correspondence Address: Der-Da Huang, 235 Chung-Ho, Box 8-24, Taipei, TW

(21) Appl. No.: 10/384,026

(22) Filed: Mar. 11, 2003

(30) Foreign Application Priority Data
Nov. 15, 2002 (TW) 91218804

(51) Int. Cl. A61J 9/04; A61J 11/02

(52) U.S. Cl. 215/11.5

(57) ABSTRACT

A nipple with an extended sleeve comprises: a suction head; an inner nipple opening at a lower end of the suction head; an air inlet valve enclosed at an edge of the nipple opening; a sleeve extended from an inner side of the air inlet valve; into a milk bottle and integrally formed with the nipple. By above structure, air flowing into nipple from the air inlet valve will flow along the “outer wall” the sleeve to a rear section of the bottle so as to be far away from the bottle opening, but the liquid in the bottle flows out along a liquid supply channel within the sleeve. Thereby, the air inlet path is isolated from the liquid outlet path. Furthermore, an outer surface of a distal end of the sleeve is formed with one of a straight folding flange, an inclined folding flange, and a concave folding flange.

### BACKGROUND OF THE INVENTION

1. Field of the Invention

The present invention relates to nipples, and particularly to a nipple with an extended sleeve which guides input air to the bottom of a baby's bottle so as not to mix with the liquid in the bottle and thus when the baby sucks the liquid, the baby will not get a plenitude.

2. Description of Related Art

The primary concern for designing a nipple is that the nipple can be sucked by a baby easily and comfortably, and moreover, the output liquid is controllable. In the process of sucking the liquid in a baby's bottle, the pressure in the bottle will be lower than that out of the bottle. If no air flows into the bottle, the liquid in the bottle cannot be sucked further.

Moreover, the lower pressure in the bottle will cause that the liquid generates bubbles. To improve this problem, an air inlet valve is installed at a flange at a lower side of the bottle. But the inlet valve is short so that the inlet air from the valve is concentrated in the periphery of the nipple, and thus the baby sucking the nipple will also suck the air and thus it is possible that the baby will have a plenitude and thus feel uneasy.

To solve above-mentioned defects, some prior arts are disclosed. In one of this prior art, a protruding tube is used to extend the valve at a bottom of the nipple so that as air into the baby's bottle will leave from the lower channel below the nipple. It can prevent air from being sucked by the baby and thus no plenitude occurs. However, some air from the protruding tube will mix with the liquid in the baby's bottle. In use, generally, the nipple is placed obliquely. Since the tube is at one side, if the tube is at the lower side, much milk is accumulated at the lower side so that the milk can not flow out easily. Moreover, when too much air is mixed with the liquid, the air in the lower side is easily sucked by a baby sucking the nipple, the baby will still get a plenitude. However, this phenomenon cannot easily be found by eyes.

Thereby, to prevent above said defect, the tube must be turned to the upper side of the nipple, but this induces an inconvenience in use. Moreover, it is very difficult for a baby.

In one prior art, an isolating air inlet tube installed between the nipple cover and the opening of a bottle is developed for guiding air out of the bottle to the bottom of the nipple, such as U.S. Pat. No. 5,779,071, “Nursing bottle with an air venting structure” and U.S. Pat. No. 5,570,796, “Nursing bottle with an air venting structure”. However, this prior art is an independent element and thus must be further assembled. Furthermore, some other complicated components are necessary to be added. Thus the cost and price are high. Furthermore, it can not be used to general baby's bottles and the user must assemble it to a dedicated baby's bottle, while the assembly process is complicated and thus is not suitable for every user.

### SUMMARY OF THE INVENTION

Accordingly, the primary object of the present invention is to provide a nipple with an extended sleeve which comprises: a suction head; an inner nipple opening at a lower end of the suction head; an air inlet valve enclosed at an edge of the nipple opening; a sleeve extended from an inner side of the air inlet valve; into a milk bottle and integrally formed with the nipple. By above structure, air flowing into nipple from the air inlet valve will flow along the “outer wall” the sleeve to a rear section of the bottle so as to be far away from the bottle opening, but the liquid in the bottle is sucked and then flows out along a liquid supply channel within the sleeve. Thereby, the air inlet path and the liquid outlet path are isolated from one another.

Another object of the present invention is to provide a nipple with an extended sleeve which comprises a section head; a wrinkle section below the suction head; a inner nipple opening at a lower end of the wrinkle section; a sleeve within the wrinkle section and extended from the suction head into a bottle, wherein the bottle has a bottle opening; an air inlet valve arranged between an inner wall of the wrinkle section and an outer wall of the sleeve.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIGS. 1A, 1B and 1C are cross section views showing three embodiments about the sleeve of the present invention.

FIG. 1D shows another embodiment of the present invention,

FIG. 2 is an assembled cross section view of the present invention.

FIG. 2A is an assembled cross section view for showing the operation of the present invention.

FIG. 3 is an assembled cross section view of embodiment shown in FIG. 1D.

FIG. 3A is an assembled cross section view for showing the operation of the embodiment in FIG. 1D.

### BRIEF DESCRIPTION OF THE PREFERRED EMBODIMENTS

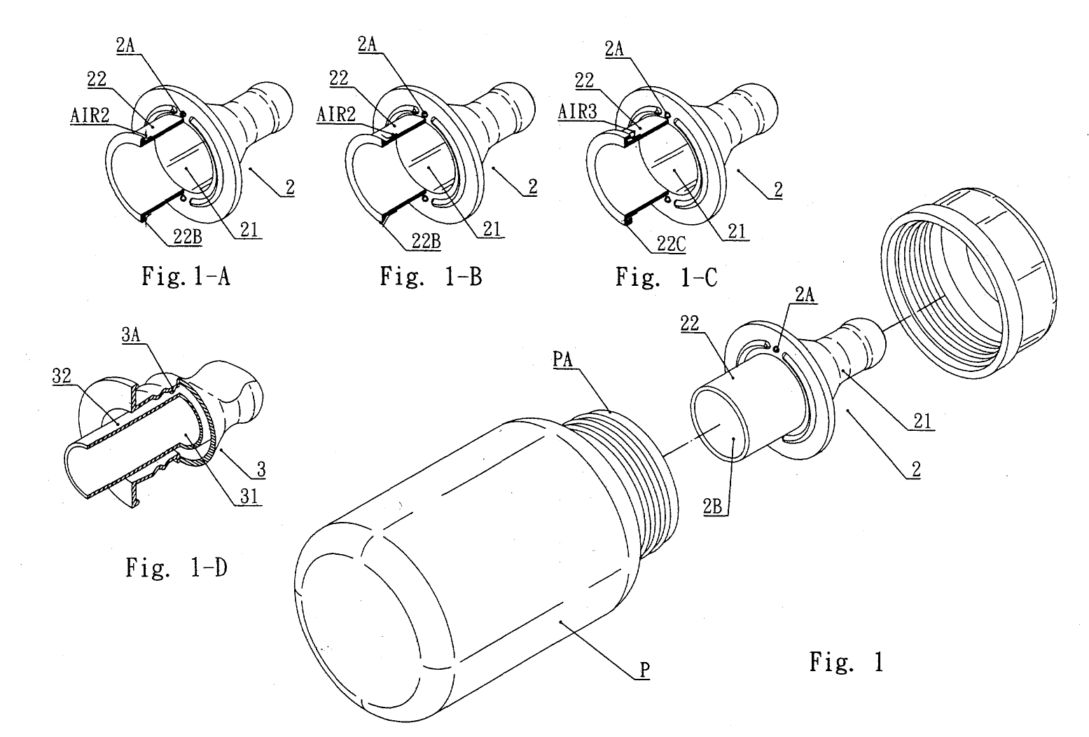

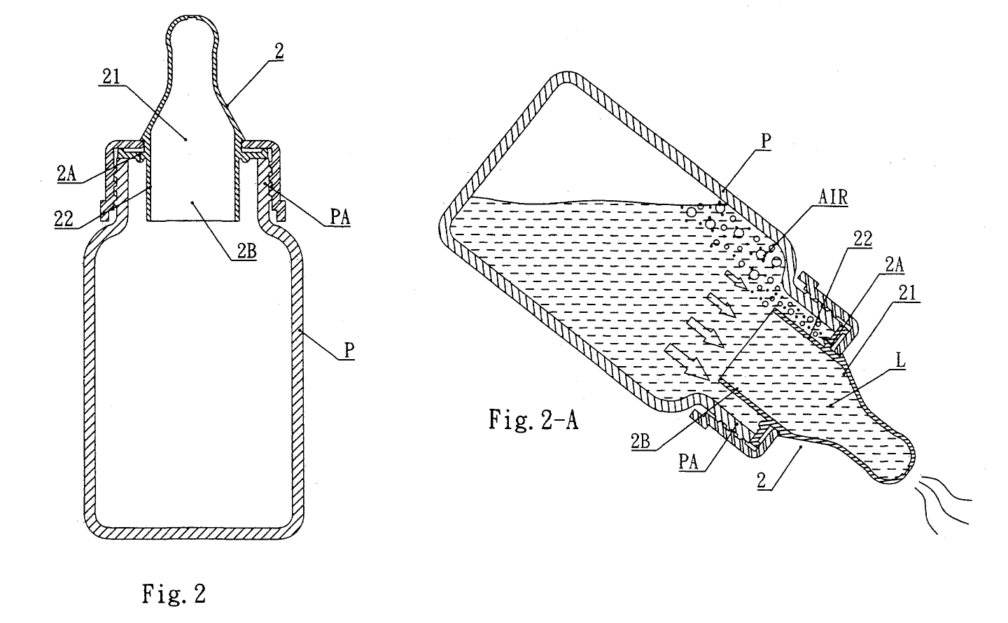

Referring to FIGS. 1 and 2A, the present invention will be described herein. The nipple with an extended sleeve has a nipple 2.

The nipple 2 has a suction head 20, a nipple opening 21, an air inlet valve 2A, and a sleeve 22.

The inner nipple opening 21 is at a lower end of the suction head 20.

The air inlet valve 2A is enclosed at an edge of the nipple opening 21.

The sleeve 22 is extended from an inner side of the air inlet valve 2A into a milk bottle P and is integrally formed with the nipple 2, wherein the bottle P has a bottle opening PA.

By above structure, air flowing into nipple 2 from the air inlet valve 2A will flow along the “outer wall” the sleeve 22 to a rear section of the bottle P so as to be far away from the bottle opening PA, but the liquid L in the bottle P is sucked and then flows out along a liquid supply channel 2B within the sleeve 22. Thereby, the air inlet path and the liquid outlet path are isolated from one another. Thus air AIR will not flow out with the liquid in the bottle P. Therefore when baby sucks the liquid L in the bottle P, the baby will not such air, and thus no plenitude occurs.

With reference to FIG. 2A, generally, the bottle P is used obliquely. The pressure distribution is illustrated by the arrows shown in the bottle P.

The longer the arrow, the larger the pressure. Thereby, it is seen that the lower section of the liquid L has a larger pressure and the upper section of the liquid has a smaller pressure. From FIG. 2A, it is illustrated that air flows into the liquid L from the outer periphery of the sleeve 22 will accumulate at the upper section of the liquid L so not to be in the liquid supply channel 2B. Thus air will not be suck with sucked liquid. Thereby, the baby can suck the liquid successfully. No plenitude occurs.

With reference to FIGS. 1A, 1B and 1C, to form an external air flow path, an outer surface of a distal end of the sleeve 22 is formed with a vertical folding flange 22A with flow path AIR1 shown in FIG. 1A, an inclined folding flange 22B with flow path AIR2 shown in FIG. 1B, and a concave folding flange 22C with flow path AIR3 shown in FIG. 1C for guiding air flow. Therefore, the air path along the sleeve 22 is prolonged and far away from a center of the liquid supply channel 2B. Thus air cannot be sucked out with the liquid in the bottle P. Thereby, plenitude is prevented.

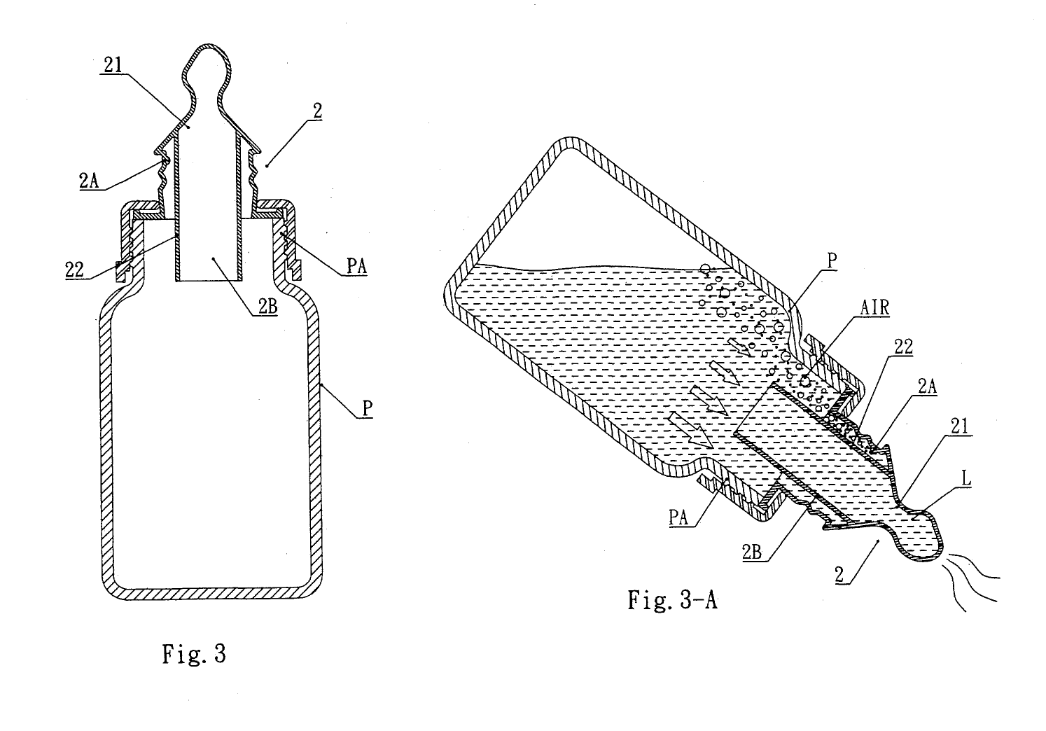

Referring to FIGS. 1D, 3 and 3A, a further embodiment of the present invention is illustrated. Other than installing the air inlet valve 2A at a periphery of the inner nipple opening 21 (such as those shown in FIGS. 1A, 1B and 1C), the nipple with an extended sleeve of the present invention has a nipple 2.

The nipple 2 has a suction head 30, a wrinkle section 35, a nipple opening 31, an air inlet valve 3A, and a sleeve 32.

The wrinkle section 35 is arranged below the suction head 30;

The inner nipple opening 31 is at a lower end of the wrinkle section 35.

The sleeve 32 is arranged within the wrinkle section and extended from the suction head 30 into a milk bottle P, wherein the bottle P has a bottle opening PA.

The air inlet valve is arranged between an inner wall of the wrinkle section 35 and an outer wall of the sleeve 32.

By above structure, air flowing into nipple 3 from the air inlet valve 3A will flow along the “outer wall” the sleeve 22 to a rear section of the bottle P so as to be far away from the bottle opening PA, but the liquid L in the bottle P is sucked and then flows out along a liquid supply channel 3B within the sleeve 32. Thereby, the air inlet path and the liquid outlet path are isolated from one another. Thus air AIR will not flow out with the liquid in the bottle P. Therefore when baby sucks the liquid L in the bottle P, the baby will not such air, and thus no plenitude occurs.

What is claimed is:

1. A nipple with an extended sleeve; comprising:
a suction head;
an inner nipple opening at a lower end of the suction head;
an air inlet valve enclosed at an edge of the nipple opening;
a sleeve extended from an inner side of the air inlet valve; into a milk bottle and integrally formed with the nipple,
wherein by above structure, air flowing into nipple from the air inlet valve will flow along the “outer wall” the sleeve to a rear section of the bottle so as to be far away from the bottle opening, but the liquid in the bottle is sucked and then flows out along a liquid supply channel within the sleeve; thereby, the air inlet path and the liquid outlet path are isolated from one another.

2. The nipple with an extended sleeve as claimed in claim 1, wherein an outer surface of a distal end of the sleeve is formed with one of a vertical folding flange, an inclined folding flange, and a concave folding flange;
therefore, air flow path along the sleeve is prolonged and far away from an axial center of sleeve which is the flow path of the liquid.

3. A nipple with an extended sleeve of the present invention comprising:
a section head;
a wrinkle section below the suction head;
a inner nipple opening at a lower end of the wrinkle section;
a sleeve within the wrinkle section and extended from the suction head into a bottle, wherein the bottle has a bottle opening;
an air inlet valve arranged between an inner wall of the wrinkle section and an outer wall of the sleeve;
wherein by above structure, air flowing into nipple from the air inlet valve will flow along the “outer wall” the sleeve to a rear section of the bottle so as to be far away from the bottle opening, but the liquid in the bottle is sucked and then flows out along a liquid supply channel within the sleeve; thereby, the air inlet path and the liquid outlet path are isolated from one another.
